(19) United States
(12) Patent Application Publication
(10) Pub. No.: US 2025/0142453 A1
(43) Pub. Date: May 1, 2025

(54) PROXY TRANSMISSION WITH META ATTRIBUTE

(71) Applicant: Samsung Electronics Co., Ltd., Suwon-si (KR)

(72) Inventors: Matthew Tonnemacher, Allen, TX (US); Bilal Sadiq, Plano, TX (US)

(21) Appl. No.: 18/916,547

(22) Filed: Oct. 15, 2024

Related U.S. Application Data
(60) Provisional application No. 63/546,873, filed on Nov. 1, 2023.

(51) Int. Cl. H04W 48/08; H04W 48/16; H04W 84/12

(52) U.S. Cl. CPC H04W 48/08; H04W 48/16; H04W 84/12

(57) ABSTRACT

An embodiment includes a station (STA) in a wireless network, the STA comprising a memory and a processor coupled to the memory, the processor configured to receive, from an origin STA, a first discovery frame that includes one or more attributes intended for proxied transmission, generate a second discovery frame that includes the one or more attributes intended for proxied transmission based on the first discovery frame and appends additional information, wherein the additional information includes an indication that the one or more attributes are associated with the origin STA and that the one or more attributes are being transmitted by proxy transmission, and wherein the additional information includes address information for the origin STA, and transmit, to one or more other STAs, the second discovery frame.

### CROSS-REFERENCE TO RELATED APPLICATION

This application claims the benefit of priority from U.S. Provisional Application No. 63/546,873, entitled “ENCAPSULATE AN ORIGIN DEVICE'S NAN ATTRIBUTES INTO A PROXY DEVICE'S SDF USING A META SDA” filed Nov. 1, 2023, all of which is incorporated herein by reference in its entireties.

### TECHNICAL FIELD

This disclosure relates generally to a wireless communication system, and more particularly to, for example, but not limited to, encapsulating an origin device's NAN attributes into a proxy device's service discovery frame (SDF) using a meta service descriptor attribute (SDA).

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

Wi-Fi Aware, also known as Neighbor Awareness Networking (NAN), is a specification put forward by the Wi-Fi Alliance that focuses on ad-hoc peer to peer (P2P) networking. The specification allows devices to connect with each other to fulfill specific service-based needs. A feature of this specification is Discovery. NAN Discovery may be handled by a NAN Discovery Engine, and can include publishing services advertisements for devices in a NAN network. NAN service advertisements are typically transmitted multiple times (e.g., periodically) by a device in a NAN cluster. A device offering/requesting a service may do the service advertisement. Many devices have limited power, so frequently transmitting advertisements can be a costly activity.

There are numerous ways to publish services advertisements. For example, a NAN device can initiate periodic publish messages to solicit a subscription to the service(s). Conversely, a NAN device can instead initiate by repeatedly (e.g., periodically) sending subscribe messages to search for another device offering specific services. In either case, to increase the likelihood of finding a matching publisher/subscriber, these messages may need to be sent repeatedly for an extended time.

The description set forth in the background section should not be assumed to be prior art merely because it is set forth in the background section. The background section may describe aspects or embodiments of the present disclosure.

### SUMMARY

One aspect of the present disclosure provides a station (STA) in a wireless network, the STA comprising a memory and a processor coupled to the memory. The processor is configured to receive, from an origin STA, a first discovery frame that includes one or more attributes intended for proxied transmission. The processor is configured to generate a second discovery frame that includes the one or more attributes intended for proxied transmission based on the first discovery frame and appends additional information, wherein the additional information includes an indication that the one or more attributes are associated with the origin STA and that the one or more attributes are being transmitted by proxy transmission, and wherein the additional information includes address information for the origin STA. The processor is configured to transmit, to one or more other STAs, the second discovery frame.

In some embodiments, the second discovery frame includes one or more attributes associated with a different origin STA and address information of the different origin STA associated with the one or more attributes.

In some embodiments, the second discovery frame includes one or more different origin STAs, associated address information for each of the one or more different origin STAs, and one or more indices each associated with a respective one of the one or more different origin STAs.

In some embodiments, the second discovery frame has a unique service identifier that is used to identify the second discovery frame as having proxied attributes.

In some embodiments, the second discovery frame includes an attribute that stores the additional information including the indication that the one or more attributes are associated with the origin STA and the address information for the origin STA.

In some embodiments, the processor is further configured to repeatedly transmit, to the one or more STAs, the second discovery frame.

In some embodiments, an attribute in the one or more attributes is associated with a service that the origin STA offers to the one or more other STAs or a service that the origin STA seeks from the one or more other STAs.

One aspect of the present disclosure provides a station (STA) in a wireless network, the STA comprising a memory and a processor coupled to the memory. The processor is configured to receive, from a proxy STA, a first discovery frame that includes one or more attributes and additional information, wherein the additional information includes an indication that the one or more attributes are associated with an origin STA and that the one or more attributes are being transmitted by proxy transmission, and wherein the additional information includes address information for the origin STA. The processor is configured to obtain, from the additional information, the address information of the origin STA and the one or more attributes associated with the origin STA based on the first discovery frame. The processor is configured to transmit, to the origin STA, a second frame using the address information.

In some embodiments, the first discovery frame includes one or more attributes associated with a different origin STA and address information of the different origin STA associated with the one or more attributes.

In some embodiments, the additional information includes one or more different origin STAs, associated address information for each of the one or more different origin STAs, and one or more indices each associated with a respective one of the one or more different origin STAs.

In some embodiments, the first discovery frame has a unique service identifier that is used to identify the first discovery frame as having additional information.

In some embodiments, the first discovery frame includes an attribute that stores the additional information including the indication that the one or more attributes are associated with the origin STA and the address information for the origin STA.

In some embodiments, an attribute in the one or more attributes is associated with a service that the origin STA offers to the one or more other STAs or a service that the origin STA seeks from the one or more other STAs.

### BRIEF DESCRIPTION OF THE DRAWINGS

FIG. 1 illustrates an example of a wireless network in accordance with an embodiment.

FIG. 2A illustrates an example of AP in accordance with an embodiment.

FIG. 2B illustrates an example of STA in accordance with an embodiment.

FIG. 3 illustrates an example of multi-link communication operation in accordance with an embodiment.

FIG. 4 illustrates an architecture of a Neighbor Awareness Networking (NAN) engine in accordance with an embodiment.

FIG. 5 illustrates an operation between two devices engaging in discovery through a proxy device in accordance with an embodiment.

FIG. 6 illustrates a flow chart of an example process of operations of a proxy device generating an SDF with an appended meta SDA in accordance with an embodiment.

FIG. 7 illustrates a flow chart of an example process of a connecting device operation upon receiving an SDF in accordance with an embodiment.

FIG. 8 illustrates an example communication between an origin device, a proxy device and a connecting device in accordance with an embodiment.

FIG. 9 illustrates a Proxy Meta SDA field layout in accordance with an embodiment.

FIG. 10 illustrates a flow chart of an example process of proxy device operation upon receiving an SDF from an origin device in accordance with an embodiment.

FIG. 11 illustrates a flow chart of an example process of a connecting device operation upon receiving an SDF in accordance with an embodiment.

FIG. 12 illustrates an example communication between an origin device, a proxy device and a connecting device in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

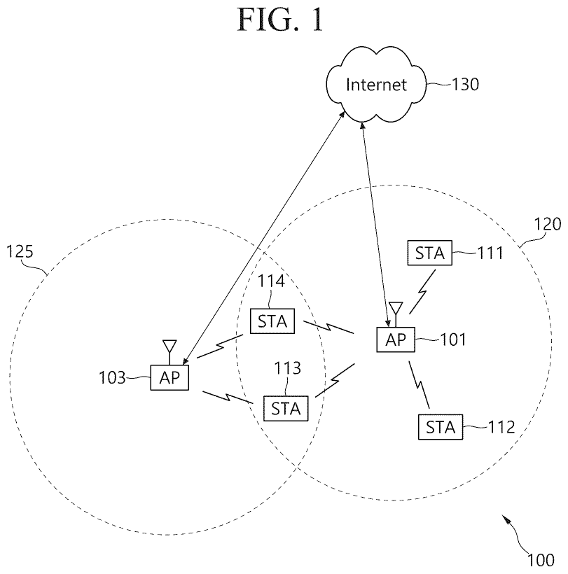

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

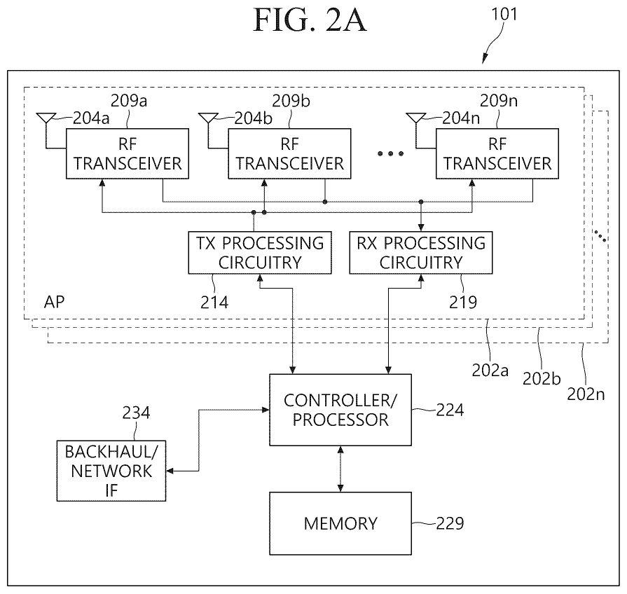

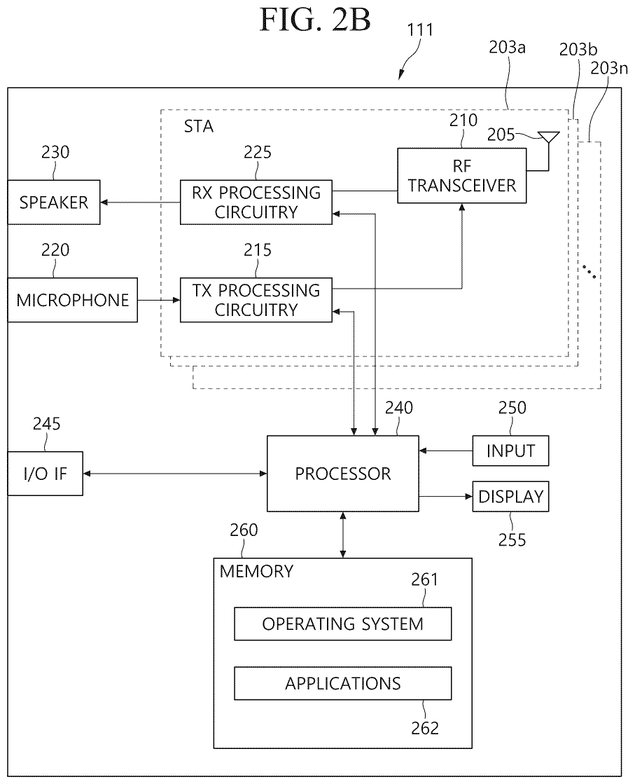

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

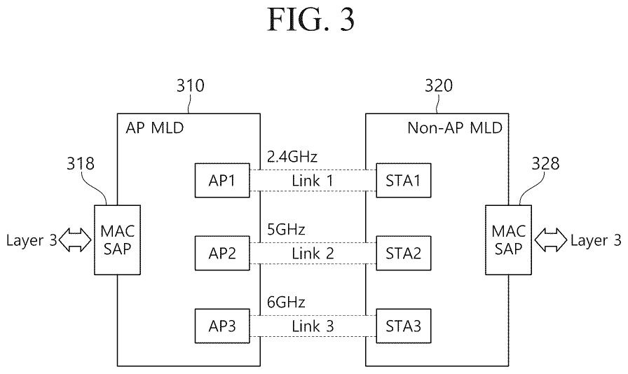

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

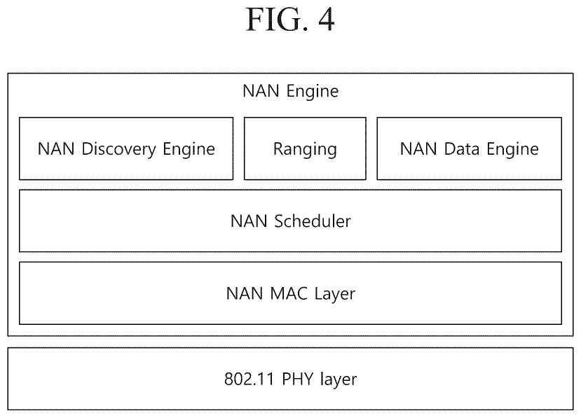

FIG. 4 illustrates an architecture of a NAN engine in accordance with an embodiment. The NAN engine may include a NAN discovery engine module, a Ranging module, a NAN Data Engine module, a NAN Scheduler module, a NAN Medium Access Control (Mac) layer module, and an 802.11 PHY Layer module.

The NAN discovery engine may be responsible for discovering devices and/or services made available on devices for specific services through Publish and Subscribe messages. Publish messages may advertise a service(s) offered by a NAN device and subscribe messages may advertise a willingness to engage with a device that offers a service(s).

The Ranging module may estimate the distance between NAN Devices that support the ranging capability. Ranging may be used in addition to the service discovery mechanism to estimate the distance to a NAN device providing a specific service. The NAN Data Engine module may provide the NAN Data Link (NDL) capability that may be used to setup a data link between NAN Devices. The NAN Scheduler module may establish, maintain, and terminate Wi-Fi radio resource schedules for NAN operations. The NAN Scheduler module may also be responsible for coordinating concurrent NAN and Non-NAN operations. The NAN MAC layer module may process and handle the NAN Beacon frames and NAN Service Discovery frames. The 802.11 PHY Layer module may provide data transport services to higher layers.

As described, NAN Discovery is handled by the NAN Discovery Engine (e.g., as illustrated in FIG. 4) and is responsible for discovering devices (or services made available on devices) for specific services through publish and/or subscribe messages. Publish messages may advertise, or make discoverable, a service(s) offered by a NAN device and subscribe messages may advertise the will to engage with or request a publish message from a device that offers a service(s).

There are various ways to accomplish a publish/subscribe handshake. For example, a NAN device can initiate periodic publish messages to solicit a subscription or a follow-up to the service(s). Conversely, a NAN device can instead initiate by repeatedly (e.g., periodically) sending subscribe messages to search for another device offering specific services. In either case, to increase the likelihood of finding a matching publisher/subscriber, these messages may need to be sent repeatedly for an extended time. A proxy device may publish/subscribe on behalf of one or more other devices. This may provide certain benefits, including saving on channel congestion (e.g., in the case of multiple devices using one proxy) or allowing the origin devices to save power.

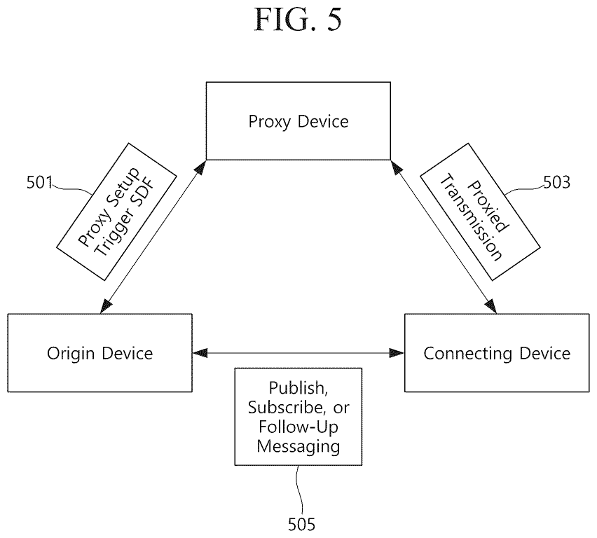

FIG. 5 illustrates an operation between two devices engaging in discovery through a proxy device in accordance with an embodiment. The devices may include an origin device, which may be a device that wants its publish and/or subscribe messages transmitted through a proxy device. The proxy device may be a device that transmits publish and/or subscribe messages 505 on behalf of an origin device. The connecting device may be a device that wishes to subscribe to (or follow-up on) a service of an origin device or publish a service to an origin device. For example, an origin device on whose behalf the connecting device received a subscribe message 503 transmitted by a proxy device. As illustrated, the origin device may communicate, including transmitting an SDF 501, with the proxy device. The proxy device may transmit a proxied transmission 503, which may include transmitting an SDF that has been derived from the SDF received from the origin device, to the connecting device. Accordingly, the origin device may communicate 505 (e.g., publish, subscribe, or follow-up messaging) with the connecting device.

Embodiments in accordance with this disclosure may provide a method for a proxy device to encapsulate an origin device's attributes into a proxy transmission such that the connecting device can both identify whether the received attributes came from a proxy device or an origin device as well as transmit follow-up messaging to the origin device directly.

When receiving an SDF that includes services of interest, a connecting device may want to respond to the service of interest with a follow-up message. Typically, the connecting device may use the address present in header fields of the incoming SDF to determine the destination of follow-up messaging. However, in the case where a proxy device is used to transmit attributes on behalf of an origin device, the address present in the header field of the incoming SDF may include the address of the proxy device instead of the origin device. If the connecting device addressed the follow-up to this address, the message would not be properly received by the origin device. As such, the connecting device may need the correct address of the origin device, and may need to be able to identify whether a message is coming indirectly through the proxy device or directly from the origin device.

In some embodiments, a proxy device may provide a connecting device with one or more pieces of information embedded within a transmitted SDF to indicate the proxied transmission and to allow the connecting device to connect with the origin device. In particular, a proxy device may provide an indication that an SDF and some or all of the attributes included within the SDF were sent via proxy to the connecting device. The proxy device may also provide a means for a connecting device to determine the origin address of each attribute.

In some embodiments, a proxy device may add a meta attribute that encapsulates information, including an indication regarding whether the SDF is being sent via proxy and/or address information for an origin device, into the SDF. In some embodiments, the inclusion of the meta attribute inside of the SDF list of attributes may be, in itself, an indication that the SDF includes proxied attributes. In some embodiments, the meta attribute may also include information about which other attributes in the SDF are sent by a proxy device and an indication of which origin device they came from.

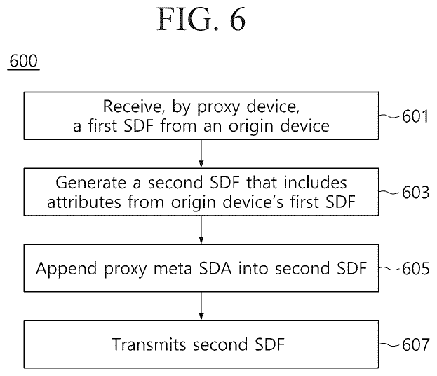

FIG. 6 illustrates a flow chart of an example process of operations of a proxy device generating an SDF with an appended meta service descriptor attribute (SDA) in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 6 illustrates operations performed in a proxy device, such as the proxy device illustrated in FIG. 5. In particular, when a received one or more attributes are intended for proxy transmission, the proxy device may include one or more of origin device's attributes into its own SDF and append a Proxy Meta SDA attribute before transmitting the SDF. The process 600 begins in operation 601.

In operation 601, the proxy device receives a first SDF from an origin device.

In operation 603, the proxy device generates a second SDF that includes one or more attributes from the origin device's first SDF. In some embodiments, the attributes that are included in the second SDF may include those attributes that are to be transmitted by proxy, which may be configured during setup between the origin device and the proxy device.

In operation 605, the proxy device appends a proxy meta SDA into the second SDF. In some embodiments, the proxy meta SDA may include an indication that an SDF and one or more of the attributes included within the SDF are being sent via proxy to a connecting device. In some embodiments, the proxy meta SDA may include address information for the origin device(s) associated with the one or more attributes and thus provide a means for a connecting device to determine the origin address of each attribute.

In operation 607, the proxy device transmits the second SDF.

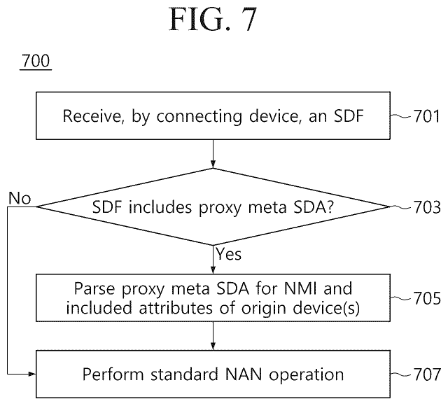

FIG. 7 illustrates a flow chart of an example process of a connecting device operation upon receiving an SDF in accordance with an embodiment. Although one or more operations are described or shown in particular sequential order, in other embodiments the operations may be rearranged in a different order, which may include performance of multiple operations in at least partially overlapping time periods. The flowchart depicted in FIG. 7 illustrates operations performed in a connecting device, such as the connecting device illustrated in FIG. 5. The process 700 begins in operation 701.

In operation 701, the connecting device receives an SDF.

In operation 703, the connecting device determines whether the SDF include a proxy meta SDA. In particular, when receiving an SDF, the connecting device may first need to evaluate whether each attribute was transmitted via proxy or not. The inclusion of a Proxy Meta SDA in the received SDF may indicate that one or more attributes was transmitted via proxy.

In operation 703, if a proxy meta SDA is included, the process proceeds to operation 705 where the connecting device parses (or extracts) the proxy meta SDA for one or more NAN management Interface (NMI) of the origin device(s) and list of attributes that correspond to each NMI. In this way, the connecting device may know which attributes originated from which devices.

In operation 707, the connecting device performs standard NAN operations. If in operation 703, the connecting devices determines that the SDF does not include proxy meta SDA, then the process proceeds to operation 707.

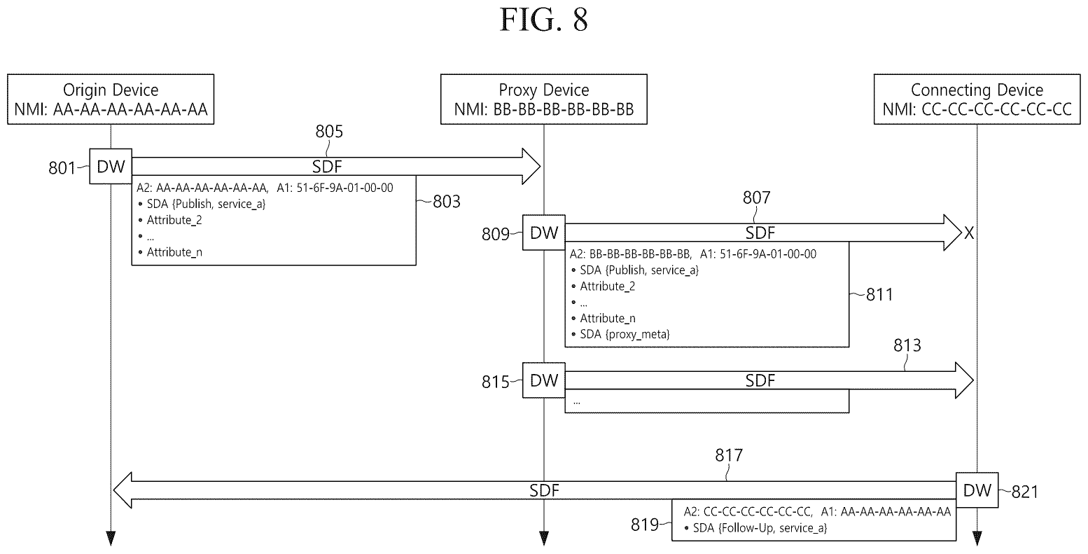

FIG. 8 illustrates an example communication between an origin device, a proxy device and a connecting device in accordance with an embodiment. In particular, origin device has an NMI address of “AA-AA-AA-AA-AA-AA”, proxy device has an NMI address of “BB-BB-BB-BB-BB-BB” and connected device has an NMI address of “CC-CC-CC-CC-CC-CC”. FIG. 8 illustrates various communications during four different discovery windows (DWs).

As illustrated, the origin device broadcasts 805 during a first discovery window (DW) 801 an SDF 803 with a publish SDA for service_a, illustrated as “SDA {Publish, service_a}”. In this example, the SDA and related Attribute2 . . . . Attribute_n are intended for proxy transmission by the proxy device. The proxy device creates an SDF 8011 that includes the origin device's SDA and Attribute_2 . . . . Attribute_n along with a new meta attribute, the Proxy Meta SDA, illustrated as “SDA {proxy_meta}” within SDF 811, and begins repeated transmissions of the SDF 811, including transmitting SDF 807 during a DW 809 and transmitting SDF 813 during a DW 815. In some embodiments, the Proxy Meta SDA may include address information for the origin device(s) (e.g., NMI: AA-AA-AA-AA-AA-AA) associated with the one or more attributes and thus provide a means for a connecting device to determine the origin address of each attribute.

The connecting device does not receive the SDF transmission 807 during DW 809, but does receive the SDF transmission 813 during DW 815, identifies the Proxy Meta SDA, and extracts the origin device NMI for the service_a SDA and related attributes. The connecting device then sends a follow-up transmission 817 of SDF 819 during a DW 821 for service_a addressed to the origin device (i.e., with NMI of A1:AA-AA-AA-AA-AA-AA) rather than the proxy device.

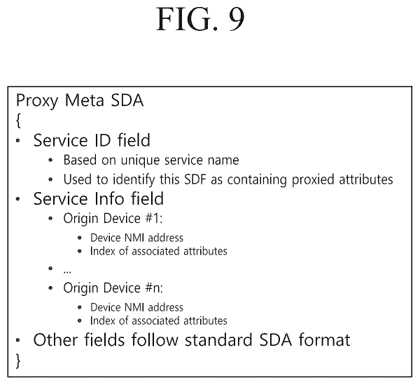

In some embodiments, a Proxy Meta SDA itself may follow a standardized SDA format. In some embodiments, a distinguishing point for the Proxy Meta SDA may be in the Service ID field and the Service Info field, as shown in FIG. 9 in accordance with an embodiment.

FIG. 9 illustrates a Proxy Meta SDA field layout in accordance with an embodiment. As illustrated, the Proxy Meta SDA may include a Service ID field, a Service Info field, and one or more other fields that may follow a standard SDA format. The Service ID field may be based on a unique service name and may be used to identify this SDF as including proxied attributes. In some embodiments, the Service ID should be a unique bit sequence that may be used to identify the SDF as including proxied attributes. The Service ID may also indicate to the receiving device that the Service Info field may need to be parsed differently than typical SDAs. For example, instead of blindly passing the Service Info field to the application layer, the firmware may need to parse the Service Info field for the Proxy Meta SDA itself to resolve addressing for potential follow-up messaging or to adjust Discovery Event trigger criteria, among other operations. The Service Info field may include one or more origin devices (e.g. origin device #1 to origin device #n), and each origin device may include meta information, including a device NMI address and an index of associated attributes. In particular, for each origin device that sent proxied attributes via the proxy device, the origin device's NMI address along with an indication of associated attributes may be present. The indication of associated attributes may be implemented using various techniques, including but not limited to as a binary bitmap of all attributes in the SDF, among other techniques.

In some embodiments, an attribute may be defined and used to store meta information regarding one or more origin device addresses and related attributes instead of using an SDA attribute. This attribute may be referred to herein as the Proxy Meta Attribute (PMA). In some embodiments, the PMA may follow a standard format for a NAN Attribute, including a unique Attribute ID field and a Length field. Similarly to the inclusion of the Proxy Meta SDA as utilized in accordance with several embodiments, the PMA may be included in a proxy device SDF that includes one or more proxied attributes. The PMA may include a structure for storing various information for each origin device for which the proxy device's SDF is carrying proxied attributes for, including information regarding origin Device NMI address and indication of attributes associated with the origin device, among others.

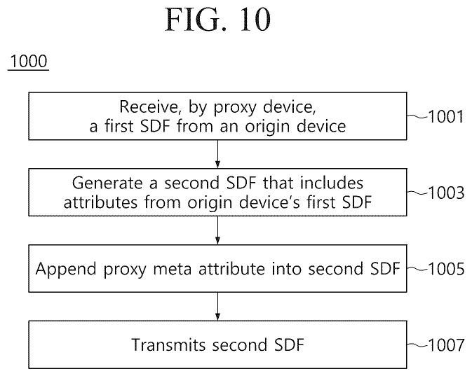

FIG. 10 illustrates a flow chart of an example process of proxy device operation upon receiving an SDF from an origin device in accordance with an embodiment. Although one or more operations are described or shown in particular sequential order, in other embodiments the operations may be rearranged in a different order, which may include performance of multiple operations in at least partially overlapping time periods. The flowchart depicted in FIG. 10 illustrates operations performed in a proxy device, such as the proxy device illustrated in FIG. 5.

In particular, when the receiving one or more attributes that are intended for proxy transmission, the proxy device may include the origin device's attributes into its own SDF and append a PMA that includes meta information regarding these attributes before transmitting the SDF.

The process 1000 begins in operation 1001. In operation 1001, the proxy device receives a first SDF from an origin device.

In operation 1003, the proxy device generates a second SDF that includes one or more attributes from the origin device's first SDF. In some embodiments, the attributes that are included in the second SDF may include those attributes that are to be transmitted by proxy, which may be configured during setup between the origin device and the proxy device.

In operation 1005, the proxy device appends a proxy meta attribute into the second SDF. In some embodiments, the proxy meta attribute may include an indication that an SDF and one or more of the attributes included within the SDF are being sent via proxy to a connecting device. In some embodiments, the proxy meta attribute may include address information for the origin device(s) associated with various attributes and thus provide a means for a connecting device to determine the origin address of each attribute.

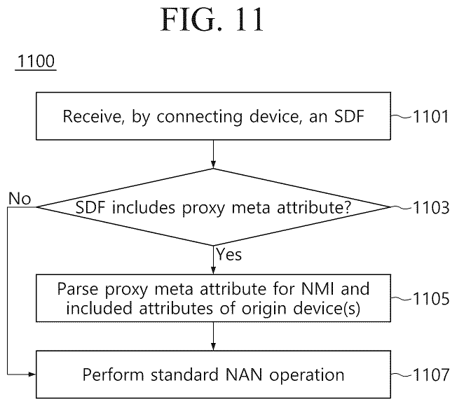

FIG. 11 illustrates a flow chart of an example process of a connecting device operation upon receiving an SDF in accordance with an embodiment. Although one or more operations are described or shown in particular sequential order, in other embodiments the operations may be rearranged in a different order, which may include performance of multiple operations in at least partially overlapping time periods. The flowchart depicted in FIG. 11 illustrates operations performed in a connecting device, such as the connecting device illustrated in FIG. 5.

The process may be similar to several embodiments that may use the ‘Proxy Meta’ SDA, but the PMA may replace the ‘Proxy Meta’ SDA and may be used for both identifying the SDF that includes attributes transmitted via proxy as well as encapsulating meta information regarding each origin device with proxied attributes in the proxy device's SDF. The process 1100 begins in operation 1101.

In operation 1101, the connecting device receives an SDF.

In operation 1103, the connecting device determines whether the SDF include a proxy meta attribute. In particular, when receiving an SDF, the connecting device may first need to evaluate whether each attribute was transmitted via proxy or not. The inclusion of a Proxy Meta attribute in the received SDF may indicate that one or more attributes was transmitted via proxy.

In operation 1103, if a proxy meta attribute is included, the process proceeds to operation 1105 where the connecting device parses (or extracts) the proxy meta attribute for one or more NMIs and included attributes of the origin device(s). In this way, the connecting device may know which attributes originated from which devices.

In operation 1107, the connecting device performs standard NAN operations. If in operation 1103, the connecting devices determines that the SDF does not include a proxy meta attribute, then the process proceeds to operation 1107.

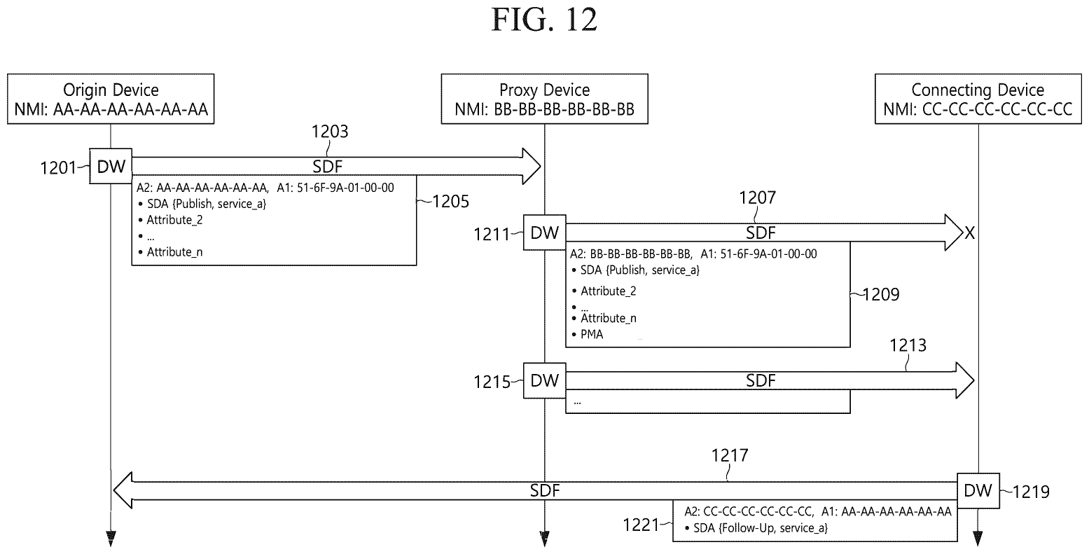

FIG. 12 illustrates an example communication between an origin device, a proxy device and a connecting device in accordance with an embodiment. The communication example is similar to FIG. 8, however the SDF includes a proxy meta attribute rather than a proxy meta SDA. In particular, origin device has an NMI address of “AA-AA-AA-AA-AA-AA”, proxy device has an NMI address of “BB-BB-BB-BB-BB-BB” and connected device has an NMI address of “CC-CC-CC-CC-CC-CC”.

As illustrated, the origin device broadcasts 1203 an SDF 1205 during a DW 1201 with a publish SDA for service_a, illustrated as “SDA {Publish, service_a}”. In this example, the SDA and related Attribute2 . . . . Attribute_n are intended for proxy transmission by the proxy device. The proxy device creates an SDF 1209 that includes the origin device's SDA and Attribute_2 . . . . Attribute_n along with the Proxy Meta Attribute (PMA), illustrated as “PMA”, and begins repeated transmissions of the SDF 1209, including SDF transmission 1207 during DW 1211 and SDF transmission 1213 during DW 1215. The connecting device does not receive the SDF transmission 1207 during DW 1211, but does receive the SDF transmission 1213 during DW 1215, identifies the Proxy Meta Attribute, and extracts the origin device NMI for the service_a SDA and related attributes. During DW 1219, the connecting device then transmits 1217 a follow-up SDF 1221 that includes an SDA (Follow-up, service_a) addressed to the origin device (i.e., with NMI of A1:AA-AA-AA-AA-AA-AA) rather than the proxy device.

Embodiments in accordance with this disclosure can provide a proxy device that can transmit publish and/or subscribe messages on behalf of one or more other origin devices, which may improve channel congestion whereby multiple devices may use a single proxy to transmit messages. Benefits may also include allowing origin devices to save power by using the resources of a proxy device to periodically transmit messages on behalf of the origin device.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

As described herein, any electronic device and/or portion thereof according to any example embodiment may include, be included in, and/or be implemented by one or more processors and/or a combination of processors. A processor is circuitry performing processing.

Processors can include processing circuitry, the processing circuitry may more particularly include, but is not limited to, a Central Processing Unit (CPU), an MPU, a System on Chip (SoC), an Integrated Circuit (IC) an Arithmetic Logic Unit (ALU), a Graphics Processing Unit (GPU), an Application Processor (AP), a Digital Signal Processor (DSP), a microcomputer, a Field Programmable Gate Array (FPGA) and programmable logic unit, a microprocessor, an Application Specific Integrated Circuit (ASIC), a neural Network Processing Unit (NPU), an Electronic Control Unit (ECU), an Image Signal Processor (ISP), and the like. In some example embodiments, the processing circuitry may include: a non-transitory computer readable storage device (e.g., memory) storing a program of instructions, such as a DRAM device; and a processor (e.g., a CPU) configured to execute a program of instructions to implement functions and/or methods performed by all or some of any apparatus, system, module, unit, controller, circuit, architecture, and/or portions thereof according to any example embodiment and/or any portion of any example embodiment. Instructions can be stored in a memory and/or divided among multiple memories.

Different processors can perform different functions and/or portions of functions. For example, a processor 1 can perform functions A and B and a processor 2 can perform a function C, or a processor 1 can perform part of a function A while a processor 2 can perform a remainder of function A, and perform functions B and C. Different processors can be dynamically configured to perform different processes. For example, at a first time, a processor 1 can perform a function A and at a second time, a processor 2 can perform the function A. Processors can be located on different processing circuitry (e.g., client-side processors and server-side processors, device-side processors and cloud-computing processors, among others).

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A station (STA) in a wireless network, the STA comprising:
a memory; and
a processor coupled to the memory, the processor configured to:
receive, from an origin STA, a first discovery frame that includes one or more attributes intended for proxied transmission;
generate a second discovery frame that includes the one or more attributes intended for proxied transmission based on the first discovery frame and appends additional information, wherein the additional information includes an indication that the one or more attributes are associated with the origin STA and that the one or more attributes are being transmitted by proxy transmission, and wherein the additional information includes address information for the origin STA; and
transmit, to one or more other STAs, the second discovery frame.

2. The STA of claim 1, wherein the second discovery frame includes one or more attributes associated with a different origin STA and address information of the different origin STA associated with the one or more attributes.

3. The STA of claim 1, wherein the second discovery frame includes one or more different origin STAs, associated address information for each of the one or more different origin STAs, and one or more indices each associated with a respective one of the one or more different origin STAs.

4. The STA of claim 1, wherein the second discovery frame has a unique service identifier that is used to identify the second discovery frame as having proxied attributes.

5. The STA of claim 1, wherein the second discovery frame includes an attribute that stores the additional information including the indication that the one or more attributes are associated with the origin STA and the address information for the origin STA.

6. The STA of claim 1, wherein the processor is further configured to repeatedly transmit, to the one or more STAs, the second discovery frame.

7. The STA of claim 1, wherein an attribute in the one or more attributes is associated with a service that the origin STA offers to the one or more other STAs or a service that the origin STA seeks from the one or more other STAs.

8. A station (STA) in a wireless network, the STA comprising:
a memory; and
a processor coupled to the memory, the processor configured to:
receive, from a proxy STA, a first discovery frame that includes one or more attributes and additional information, wherein the additional information includes an indication that the one or more attributes are associated with an origin STA and that the one or more attributes are being transmitted by proxy transmission, and wherein the additional information includes address information for the origin STA; and
obtain, from the additional information, the address information of the origin STA and the one or more attributes associated with the origin STA based on the first discovery frame; and
transmit, to the origin STA, a second frame using the address information.

9. The STA of claim 8, wherein the first discovery frame includes one or more attributes associated with a different origin STA and address information of the different origin STA associated with the one or more attributes.

10. The STA of claim 8, wherein the additional information includes one or more different origin STAs, associated address information for each of the one or more different origin STAs, and one or more indices each associated with a respective one of the one or more different origin STAs.

11. The STA of claim 8, wherein the first discovery frame has a unique service identifier that is used to identify the first discovery frame as having additional information.

12. The STA of claim 8, wherein the first discovery frame includes an attribute that stores the additional information including the indication that the one or more attributes are associated with the origin STA and the address information for the origin STA.

13. The STA of claim 8, wherein an attribute in the one or more attributes is associated with a service that the origin STA offers to the one or more other STAs or a service that the origin STA seeks from the one or more other STAs.

14. A computer-implemented method for communicating by a station (STA) in a wireless network, comprising:
receiving, from an origin STA, a first discovery frame that includes one or more attributes intended for proxied transmission;
generating a second discovery frame that includes the one or more attributes intended for proxied transmission based on the first discovery frame and appends additional information, wherein the additional information includes an indication that the one or more attributes are associated with the origin STA and that the one or more attributes are being transmitted by proxy transmission, and wherein the additional information includes address information for the origin STA; and
transmit, to one or more other STAs, the second discovery frame.

15. The computer-implemented method of claim 14, wherein the second discovery frame includes one or more attributes associated with a different origin STA and address information of the different origin STA associated with the one or more attributes.

16. The computer-implemented method of claim 14, wherein the second discovery frame includes one or more different origin STAs, associated address information for the one or more different origin STAs, and one or more indices each associated with a respective one of the one or more different origin STAs.

17. The computer-implemented method of claim 14, wherein the second discovery frame has a unique service identifier that is used to identify the second discovery frame as having proxied attributes.

18. The computer-implemented method of claim 14, wherein the second discovery frame includes an attribute that stores the additional information including the indication that the one or more attributes are associated with the origin STA and the address information for the origin STA.

19. The computer-implemented method of claim 14, further comprising repeatedly transmitting, to the one or more STAs, the second discovery frame.

20. The computer-implemented method of claim 14, wherein an attribute in the one or more attributes is associated with a service that the origin STA offers to the one or more other STAs or a service that the origin STA seeks from the one or more other STAs.
